(19) United States
(12) Patent Application Publication
(10) Pub. No.: US 2026/0158624 A1
(43) Pub. Date: Jun. 11, 2026

(54) RATCHET WRENCH

(71) Applicants: Yi-Fu Chen, Taichung City (TW); He-Qian Chen, Taichung City (TW)

(72) Inventors: Yi-Fu Chen, Taichung City (TW); He-Qian Chen, Taichung City (TW)

(21) Appl. No.: 18/970,914

(22) Filed: Dec. 6, 2024

(51) Int. Cl. B25B 13/46; B25B 13/48

(52) U.S. Cl. CPC B25B 13/463

(57) ABSTRACT

A ratchet wrench includes a wrench head which accommodates a ratchet-pawl assembly and a direction-switching device. The ratchet-pawl assembly includes a ratchet, and first and second pawls. The first and second pawls have pawl teeth for being engaged with the ratchet teeth of the ratchet. A recessed area is formed on each first and second pawls and face away from the ratchet teeth. Each recessed area forms first and second recessed curve portions, and two recessed curve portions. The direction-switching device includes a toggle member and two cavities. Each cavity accommodates a bead and spring which pushes the bead to move in the recessed areas of the first and second pawls and push the pawl teeth with the ratchet teeth of the ratchet. The pawl teeth of the first and second pawls are respectively engage with corresponding tooth valleys and tooth tip sides of the ratchet teeth.

### BACKGROUND OF THE INVENTION

### 1. Fields of the invention

The present invention relates to a ratchet wrench, and more particularly, to a ratchet wrench that is operated with bidirectional rotation.

### 2. Descriptions of Related Art

As shown in FIGS. 8, 9, and 10, this is a known reversible ratchet wrench, with a structure that mainly includes a ratchet 2 and a pawl block 3 set inside the wrench head 1, and a switching unit 4 used to control the pawl block 3. The switching unit 4 consists of a toggle member 5, and a spring 6 and a linking member 7 installed within the toggle member 5. The linking member 7 protrudes outside the toggle member 5 under the spring force of the spring 6 and extends into the recessed area 8 of the pawl block 3. Through the left and right toggling of the toggle member 5, the direction and position of the linking member 7 and pawl block 3 correspondingly change, thereby changing the rotation direction of the ratchet 2.

The above known example has the following problems:
When the toggle member 5 is switched to change position, the linking member 7 pushes along the recessed area 8 of the pawl block 3. At this time, because the two side portions 31 of the pawl block 3 and the action wall 9 of the wrench head 1 are in linear plane contact, it causes tight pressing of the pawl block 3 and the action wall 11 without clearance easily. Therefore, during use, it can easily cause unsmooth disengagement and repositioning of the pawl block 3, giving users a stuck and jerky feeling during operation.

Because the two side portions 31 of the pawl block 3 and the action wall 9 of the wrench head 1 are in linear plane contact, the left and right deflection angle of the linking member 7 tends to be small, only about −26 degrees ˜0 degrees˜26 degrees of angular swing. This prevents achieving the maximum stopping effect between the pawl block 3 and the ratchet 2, thus resulting in insufficient maximum torque that can be achieved during use.

Since the peripheral ratchet teeth 21 of the ratchet 2 in this type of ratchet wrench design are paired with a single linking member 7, there is a limitation on the number of ratchet teeth 21. Therefore, the common number of the ratchet teeth is mostly between 60-72 teeth, which means the necessary swing angle of the wrench is 5-6 degrees. However, as technology advances, items are becoming smaller and various device installations are becoming more crowded, there is an increasing demand for ratchet wrenches with even smaller necessary swing angles. If one wants to reduce the swing angle, the number of gear teeth must be increased. However, increasing the number of teeth without changing the ratchet size would reduce the force that the teeth can withstand. If the ratchet size is increased, it would result in the wrench being unable to work in narrow spaces. How to develop a way to further reduce the necessary swing angle of the ratchet wrench without changing the ratchet size and number of ratchet teeth is a critical problem that needs to be solved today.

The recessed area 8 of the ratchet 2 in this type of ratchet wrench design is arc-shaped, with the arc curvature designed using the length of ratchet 2 as its center. Therefore, the curvature of this arc is too large, resulting in insufficient diagonal stopping force when the linking member 7 stops the pawl block 3, which naturally cannot meet modern requirements for load-bearing capacity.

The present invention intends to provide a ratchet wrench that can be operated with bidirectional rotation to eliminate the shortcomings mentioned above.

### SUMMARY OF THE INVENTION

The present invention relates to a ratchet wrench and comprises a wrench head which comprises a ratchet space and a hole. A recess is formed in an inner periphery of the ratchet space and towards the hole in the wrench head. A ratchet-pawl assembly is accommodated in the ratchet space, and a direction-switching device is installed in the hole.

The ratchet-pawl assembly comprises a ratchet, and first and second pawls. The ratchet has ratchet teeth formed in an outer periphery of the ratchet. The first pawl has first pawl teeth formed on a first side thereof facing the ratchet teeth, and the second pawl has second pawl teeth formed on a first side thereof facing the ratchet teeth. A first recessed area is formed on a second side of the first pawl and faces away from the ratchet teeth. A second recessed area is formed on a second side of the second pawl and faces away from the ratchet teeth. The first pawl has two first arc portions formed on two ends thereof and located corresponding to a shape of the recess. Similarly, the second pawl has two second arc portions formed on two ends thereof and located corresponding to the shape of the recess. The first and second pawl teeth are engaged with the ratchet teeth of ratchet. The first recessed area has a first recessed curve portion and a second recessed curve portion respectively formed to two inner ends thereof. The second recessed area has a third recessed curve portion and a fourth recessed curve portion respectively formed to two inner ends thereof. Two first protrusions protrude from the second side of the first pawl, wherein the first recessed area is located between the two first protrusions. Two second protrusions protrude from the second side of the second pawl, wherein the second recessed area is located between the two second protrusions.

A fixing member secures the ratchet-pawl assembly within the ratchet space of the wrench head. The direction-switching device includes a toggle member and two cavities formed within the direction-switching device. The cavities are located respectively corresponding to the first and second pawls. Two beads and two springs are respectively accommodated in the cavities. The beads are pushed by the springs respectively to press against the first and second recessed curved portions and the third and fourth recessed curved portions of the first and second pawls, so that the first pawl teeth and the second pawl teeth of the first and second pawls are respectively engaged with tooth valleys and tooth tip sides of the ratchet teeth of ratchet.

The main purpose of this invention is to provide a ratchet wrench device with a smaller pawl tooth engagement angle, making it more spatially convenient during use while achieving better structural stability and load-bearing capacity.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded perspective view of the ratchet wrench of the present invention;

FIG. 2 is an assembled view of the ratchet wrench of the present invention;

FIG. 2A is a longitudinal sectional view of the ratchet wrench of the present invention;

FIG. 3 is a first transverse sectional and operational view of the ratchet wrench of the present invention;

FIG. 4 is a second transverse sectional and operational view of the ratchet wrench of the present invention;

FIG. 5 is a third transverse sectional and operational view of the ratchet wrench of the present invention;

FIG. 6 is a fourth transverse sectional and operational view of the ratchet wrench of the present invention;

FIG. 7 is a sectional and operational view of another embodiment of the ratchet wrench of the present invention;

FIG. 8 is a first sectional and operational view of a conventional reversible ratchet wrench;

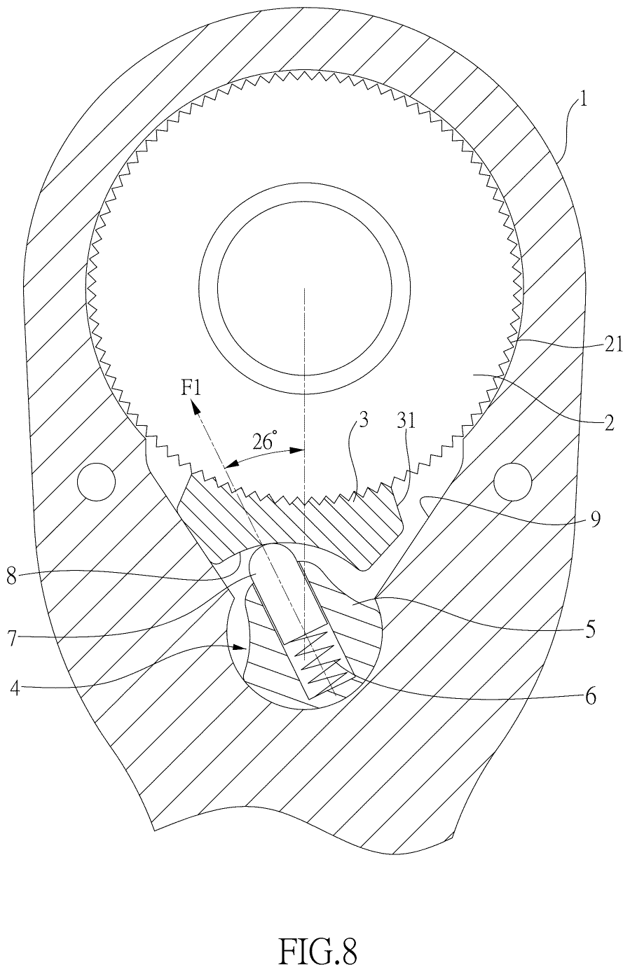

FIG. 9 is a second sectional and operational view of a conventional reversible ratchet wrench, and

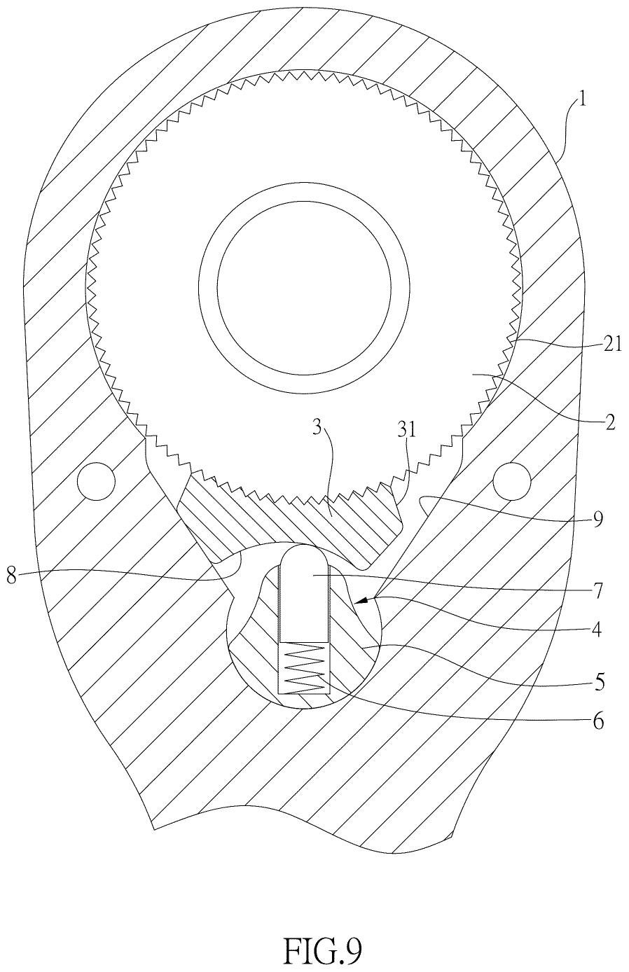

FIG. 10 is a third sectional and operational view of a conventional reversible ratchet wrench.

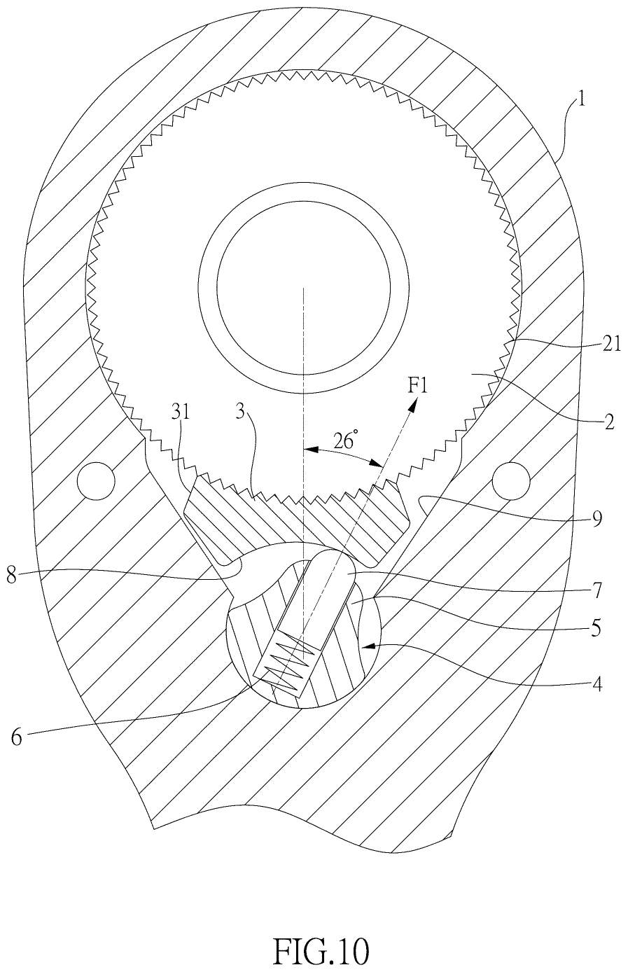

### DETAILED DESCRIPTION OF THE PREFERRED EMBODIMENT

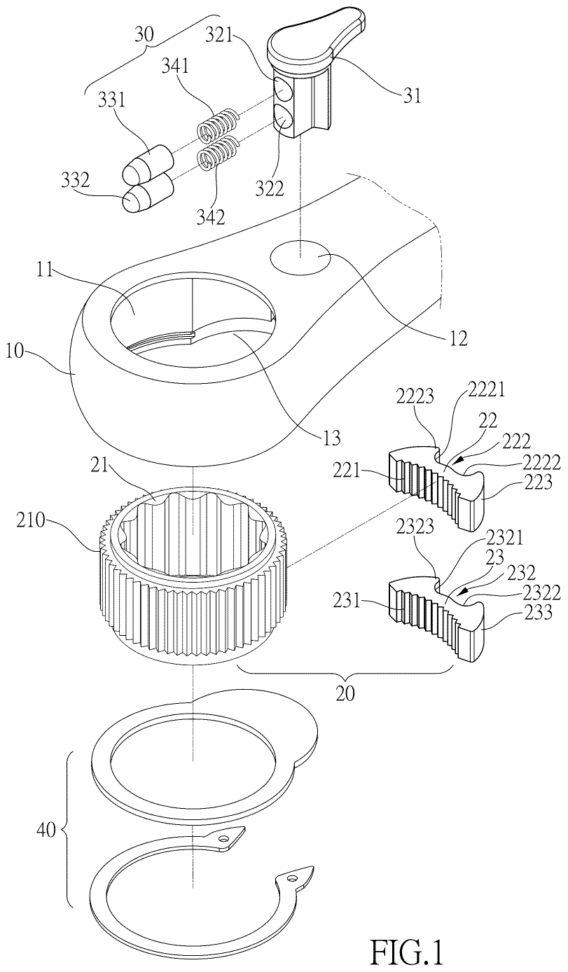

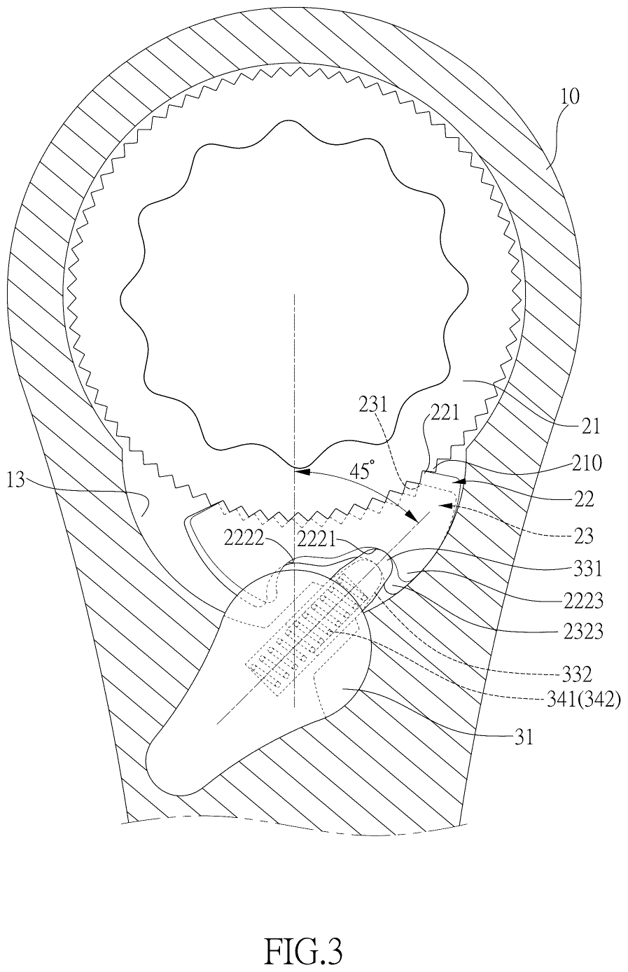

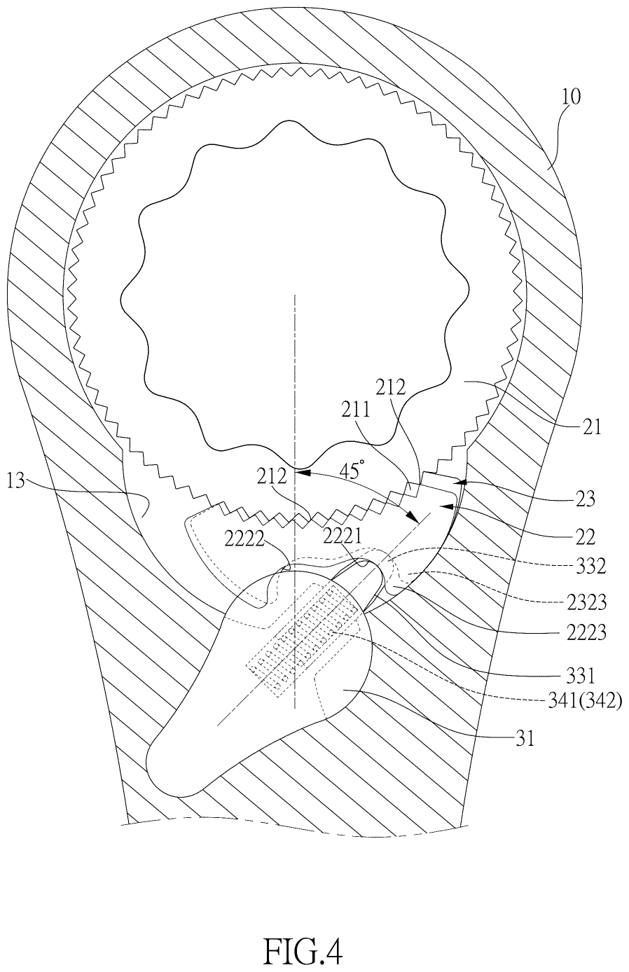

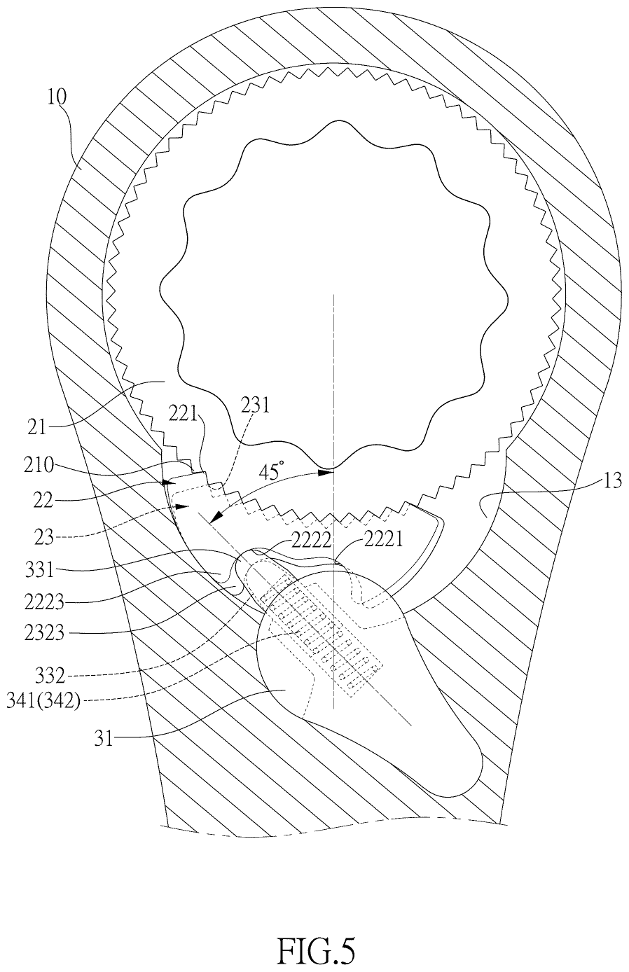

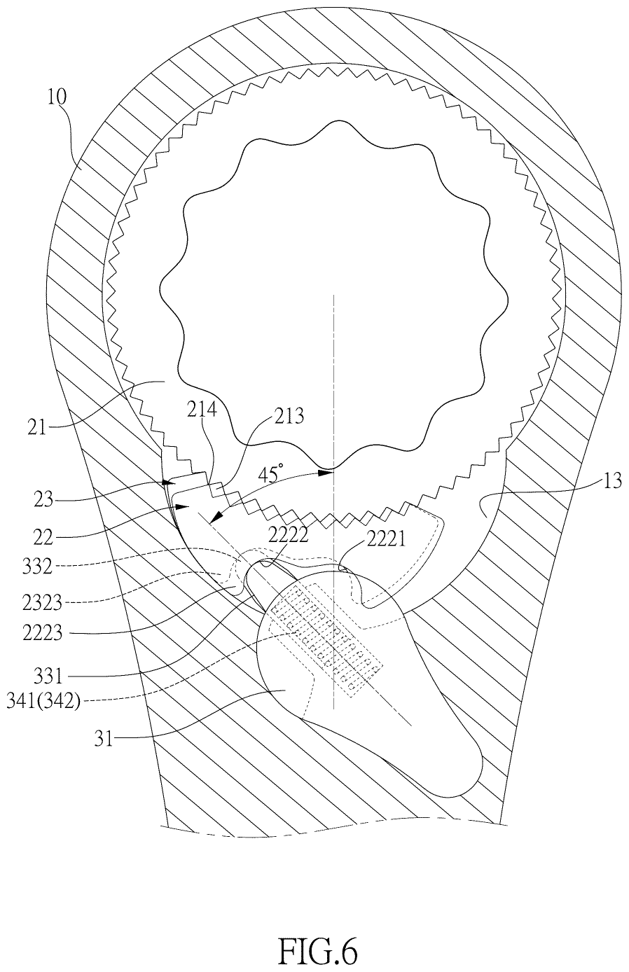

Referring to FIGS. 1 to 6, the ratchet wrench of the present invention comprises a wrench head 10 which comprises a ratchet space 11 and a hole 12. A recess 13 is formed in an inner periphery of the ratchet space 11 and towards the hole 12 in the wrench head 10. A ratchet-pawl assembly 20 is accommodated in the ratchet space 11, and a direction-switching device 30 is installed in the hole 12.

The ratchet-pawl assembly 20 comprises a ratchet 21, and first and second pawls 22, 23. The ratchet 21 has ratchet teeth 210 formed in an outer periphery of the ratchet 21. The first pawl 22 has first pawl teeth 221 formed on a first side thereof facing the ratchet teeth 210, and the second pawl 23 has second pawl teeth 231 formed on a first side thereof facing the ratchet teeth 210. A first recessed area 222 is formed on a second side of the first pawl 22 and faces away from the ratchet teeth 210. A second recessed area 232 is formed on a second side of the second pawl 23 and faces away from the ratchet teeth 210. The first pawl 22 has two first arc portions 223 formed on two ends thereof and located corresponding to a shape of the recess 13. Similarly, the second pawl 23 has two second arc portions 233 formed on two ends thereof and located corresponding to the shape of the recess 13. The first and second pawl teeth 221, 231 are engaged with the ratchet teeth 210 of ratchet 21. The first recessed area 222 has a first recessed curve portion 2221 and a second recessed curve portion 2222 respectively formed to two inner ends thereof. The second recessed area 232 has a third recessed curve portion 2321 and a fourth recessed curve portion 2322 respectively formed to two inner ends thereof. Two first protrusions 2223 protrude from the second side of the first pawl 22, wherein the first recessed area 222 is located between the two first protrusions 2223. Two second protrusions 2323 protrude from the second side of the second pawl 23, wherein the second recessed area 232 is located between the two second protrusions 2323.

A fixing member 40 secures the ratchet-pawl assembly 20 within the ratchet space 11 of the wrench head 10. The direction-switching device 30 includes a toggle member 31 and two cavities 321, 322 formed within the direction-switching device 30. The cavities 321, 322 are located respectively corresponding to the first and second pawls 22, 23. Two beads 331, 332 and two springs 341, 342 are respectively accommodated in the cavities 321, 322. The beads 331, 332 are pushed by the springs 341, 342 respectively to press against first recessed area 222 and the second recessed area 232 including the first and second recessed curved portions 2221, 2222 and the third and fourth recessed curved portions 2321, 2322 of the first and second pawls 22, 23. Therefore, the first pawl teeth 221 and the second pawl teeth 231 of the first and second pawls 22, 23 are respectively engaged with tooth valleys 211 and tooth tip sides 212 of the ratchet teeth 210 of ratchet 21.

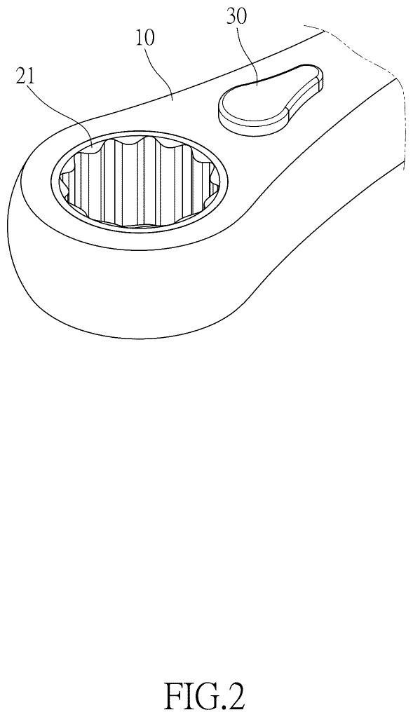

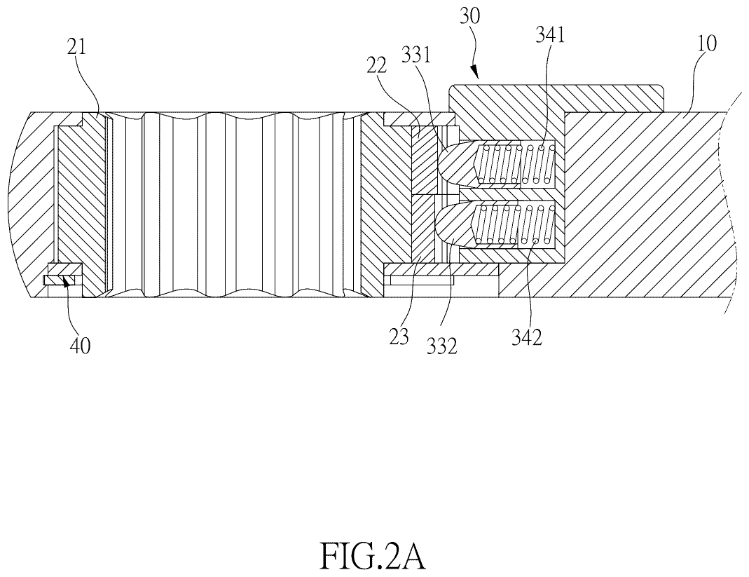

As shown in FIGS. 2 to 4, when assembling wrench device of the present invention ratchet, the ratchet-pawl assembly 20 is accommodated within the through ratchet space 11, enabling the pawl teeth 221, 231 of the first and second pawls 22, 23 to respectively engage with the tooth valleys 211 and the tooth tip sides 212 of the ratchet teeth 210. Then, the fixing member 40 is used to secure the ratchet-pawl assembly 20 within the ratchet space 11 of the wrench head 10.

Furthermore, the direction-switching device 30 is fitted into the hole 12 of the wrench head 10, allowing the beads 331, 332 accommodated within the cavities 321, 322 to be pressed by the spring force of springs 341, 342, causing the beads 331, 332 to press against the recessed curve portions 2221 and 2321 on the same side of the first and second pawls 22, 23.

When in use, as the pawl teeth 221, 231 of the first and second pawls 22, 23 are respectively engaged with the tooth valleys 211 and the tooth tip sides 212 of the ratchet teeth 210 of ratchet 21, when rotating a workpiece (not shown in the figure), it utilizes the respective engagement of the first and second pawl teeth 221, 231 of the first and second pawls 22, 23 with the tooth valleys 211 and the tooth tip sides 212 of the ratchet teeth 210. Since the first and second pawls 22, 23 are pressed by their respective beads 331, 332 within the first and third recessed curve portions 2221, 2321 of the first and second recessed areas 222, 232, it achieves the effect of contacting against the workpiece, and the overall rotation angle of the ratchet teeth 210 of the ratchet-pawl assembly 20 is approximately only half of the original angle. In other words, the angle changes from the original angle between adjacent ratchet teeth, to the angle from the tooth valley 211 to the tooth tip side 212 of the adjacent ratchet tooth 210. This allows users operating the ratchet wrench of the present invention to achieve rotation with minimal angle, greatly eliminating space limitations.

In the present invention, the first and second recessed areas 222, 232 respectively have the corresponding first and second recessed curve portions 2221, 2222 and the corresponding third and fourth recessed curve portions 2321, 2322. The curvature of the first and second recessed curve portions 2221, 2222 and the third and fourth recessed curve portions 2321, 2322 is smaller than the radius of curvature of the first and second recessed areas 222, 232, thus providing a larger arc angle and enabling the beads 331, 332 to generate greater component forces during pressing in different directions, allowing them to firmly press the first and second pawls 22, 23 against the ratchet 21. Additionally, the first and second protrusions 2223, 2323 are set at both ends of the second side of the first and second recessed areas 222, 232, and further ensures space constraint for the beads 331, 332, preventing them from leaving the first and second recessed curve portions 2221, 2222 and the third and forth recessed curve portions 2321, 2322 of the first and second pawls 22, 23.

When changing direction of the present invention, similarly through the toggling of the toggle member 31, the beads 331, 332 can be moved from the first and third recessed curve portions 2221, 2321, and respectively press against the second and fourth recessed curve portions 2222, 2322 on the other end. Likewise, the pawl teeth 221, 231 of the first and second pawls 22, 23 can respectively engage with the tooth valleys 213 and the tooth tip sides 214 of the ratchet teeth 210 of the ratchet 21 on the other side, similarly enabling users operating this invention to achieve rotation with minimal angle, greatly eliminating space limitations.

Furthermore, in the present invention, both ends of the first and second pawls 22, 23 have the first and second arc portions 223, 233 corresponding to the shape of the recess 13, therefore when the first and second pawls 22, 23 are being pressed, the first and second arc portions 223, 233 press against the recess 13 with an arc-shaped circular contact surface, achieving a maximum span of −45 degrees to 0 degrees to +45 degrees, thus reaching optimal pressing force.

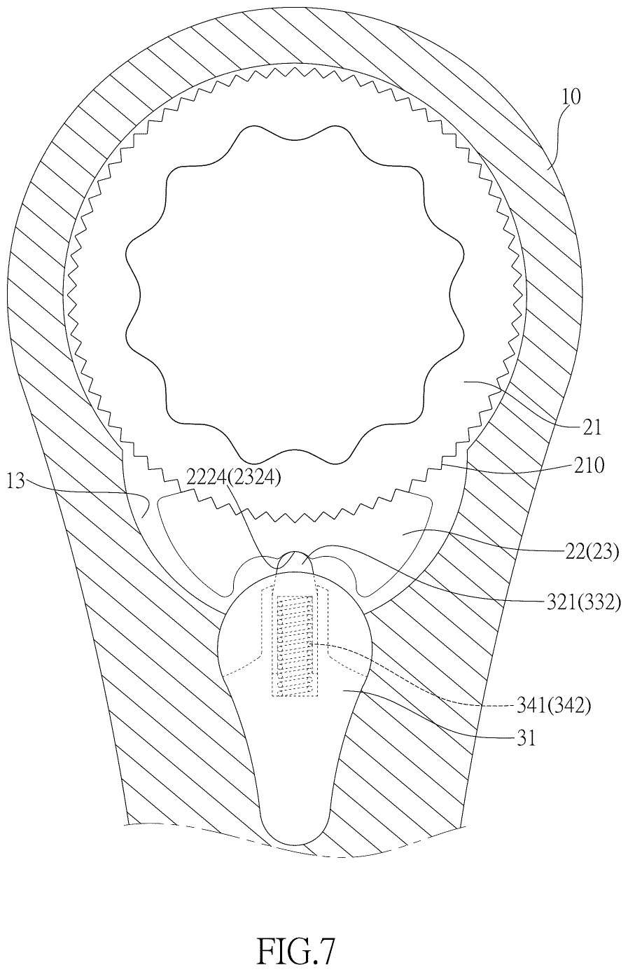

Please refer to FIG. 7 showing another embodiment of the present invention, wherein a middle recessed curve portion 2224/2324 can be additionally formed at the middle portion of each of the first and second recessed areas 222, 232. This not only allows the first and second recessed curve portions 2221, 2222 and the third and fourth recessed curve portions 2321, 2322 to have larger arc angles, but also provides a larger arc angle that enables the beads 331, 332 to generate greater component forces during pressing in different directions, allowing them to firmly press the first and second pawls 22, 23 against the ratchet 21. Furthermore, when the beads 331, 332 press against the middle recessed curve portions 2224 and 2324, they can achieve the effect of not pushing the first and second pawls 22 and 23 toward either side, which means it can enhance the smoothness of engagement with the ratchet 21.

While we have shown and described the embodiment in accordance with the present invention, it should be clear to those skilled in the art that further embodiments may be made without departing from the scope of the present invention.

What is claimed is:

1. A ratchet wrench comprising:
a wrench head having a ratchet space and a hole, a recess is formed in an inner periphery of the ratchet space and towards the hole in the wrench head, a ratchet-pawl assembly accommodated in the ratchet space, a direction-switching device installed in the hole;
the ratchet-pawl assembly including a ratchet and first and second pawls, the ratchet having ratchet teeth formed in an outer periphery of the ratchet, the first pawl having first pawl teeth formed on a first side thereof facing the ratchet teeth, the second pawl having second pawl teeth formed on a first side thereof facing the ratchet teeth, a first recessed area formed on a second side of the first pawl and facing away from the ratchet teeth, a second recessed area formed on a second side of the second pawl and facing away from the ratchet teeth, the first pawl having two first arc portions formed on two ends thereof and located corresponding to a shape of the recess, the second pawl having two second arc portions formed on two ends thereof and located corresponding to the shape of the recess, the first and second pawl teeth engaged with the ratchet teeth of ratchet, the first recessed area having a first recessed curve portion and a second recessed curve portion respectively formed to two inner ends thereof, the second recessed area having a third recessed curve portion and a fourth recessed curve portion respectively formed to two inner ends thereof, two first protrusions protruding from the second side of the first pawl, the first recessed area located between the two first protrusions, two second protrusions protruding from the second side of the second pawl, the second recessed area located between the two second protrusions;
a fixing member securing the ratchet-pawl assembly within the ratchet space of the wrench head, and
the direction-switching device including a toggle member and two cavities formed within the direction-switching device, the cavities located respectively corresponding to the first and second pawls, two beads and two springs respectively accommodated in the cavities, the beads being pushed by the springs respectively to press against the first and second recessed curved portions and the third and fourth recessed curved portions of the first and second pawls, so that the first pawl teeth and the second pawl teeth of the first and second pawls are respectively engaged with tooth valleys and tooth tip sides of the ratchet teeth of ratchet.

2. The ratchet wrench as claimed in claim 1, wherein a middle recessed curve portion is formed at a middle portion of each of the first and second recessed areas.
